(19) United States
(12) Patent Application Publication
(10) Pub. No.: US 2013/0254366 A1
(43) Pub. Date: Sep. 26, 2013

(54) COMPUTING DEVICE AND REMOTE DESKTOP MANAGEMENT METHOD

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: CHUNG-I LEE, New Taipei (TW); YI-GUO WANG, Shenzhen (CN); KUAN-CHIAO PENG, New Taipei (TW); JIAN HUANG, Shenzhen (CN); YI-MING LU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/773,676

(22) Filed: Feb. 22, 2013

(30) Foreign Application Priority Data
Mar. 22, 2012 (CN) 201210077823.5

(51) Int. Cl. H04L 12/24

(52) U.S. Cl. CPC H04L 41/00
USPC 709/223

(57) ABSTRACT

In a remote desktop management method using a computing device, a webpage including a plurality of remote devices is generated. The computing device determines a computer name and an IP address of a selected remote device, and receives display parameters of the selected remote device from the control computer. A COM object is created and configured. Using the COM object, a remote connection to the selected remote device is established based on an operation system used in the selected remote device, and a remote desktop of the selected remote device is generated on the webpage.

### BACKGROUND

1. Technical Field

Embodiments of the present disclosure relate to computer management technology, and particularly to a computing device and a remote desktop management method of the computing device.

2. Description of Related Art

In order to remotely manage desktops of remote devices, a remote desktop management application needs to be installed in a control computer. Via the control computer, users can remotely manage desktops of the remote devices. If an operating system of the control computer changes, the remote desktop management application needs to be modified, causing inconvenience to the users.

### BRIEF DESCRIPTION OF THE DRAWINGS

FIG. 1 is one embodiment of an application of a computing device.

FIG. 2 is a block diagram of one embodiment of function modules of a remote desktop management system in FIG. 1.

FIG. 3 is a flowchart of one embodiment of a remote desktop management method using the computing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

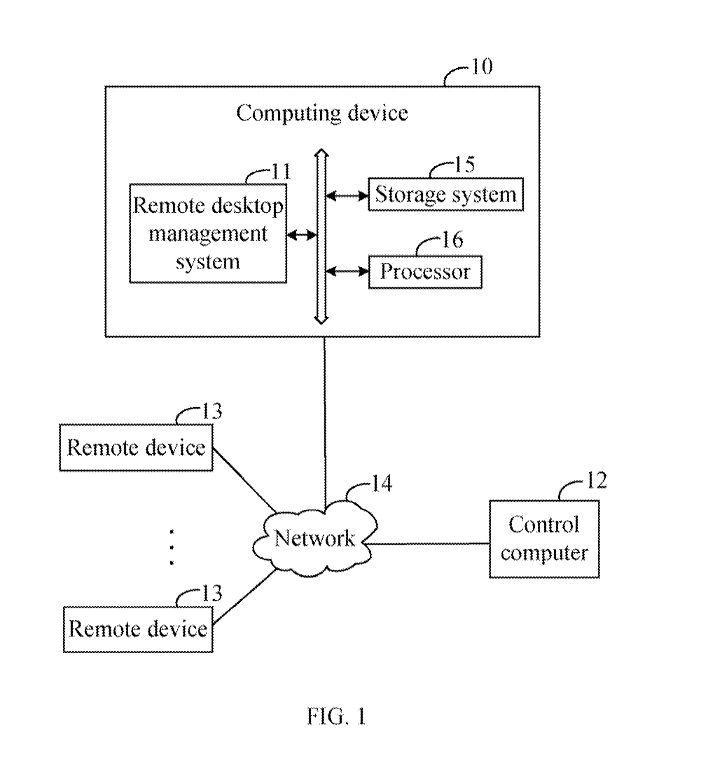

FIG. 1 is a block diagram of one embodiment of a computing device 10. The computing device 10 includes a remote desktop management system 11. The computing device 10 is connected to a control computer 12 and one or more remote devices 13 through a network 14. The remote desktop management system 11 provides a webpage for the control computer 12 to remotely manage desktops of the remote devices 13, without any remote desktop management application installed in the control computer 12. The remote devices 13 may be physical machines or virtual machines. The network 14 may be a public or private network.

In the embodiment, the computing device 10 further includes a storage system 15 and at least one processor 16. The storage system 15 may be a dedicated memory, such as an EPROM, a hard disk drive, or flash memory. In some embodiments, the storage system 15 may be an external storage device, such as an external hard disk, a storage card, or a data storage medium.

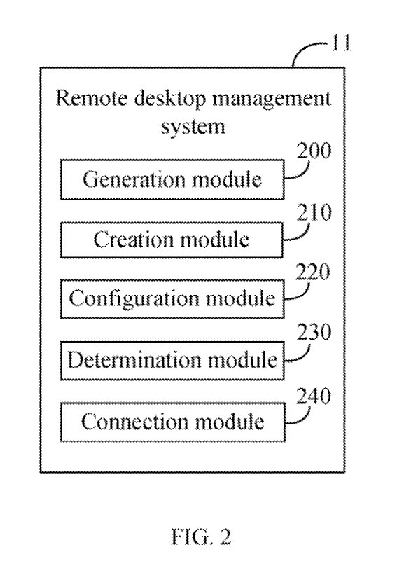

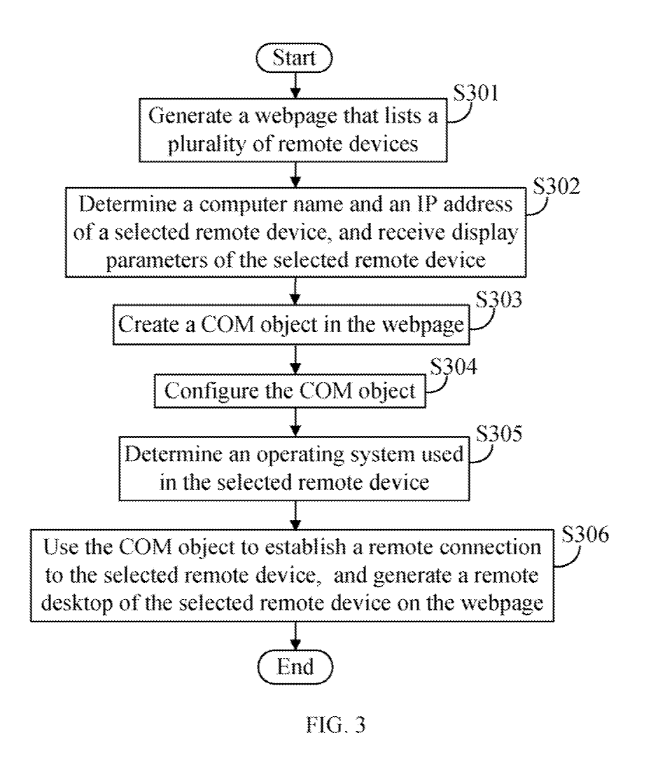

FIG. 2 is a block diagram of one embodiment of function modules of the remote desktop management system 11 in FIG. 1. The remote desktop management system 11 includes a generation module 200, a creation module 210, a configuration module 220, a determination module 230, and a connection module 240. The modules 200-240 may comprise computerized code in the form of one or more programs that are stored in the storage system 15. The computerized code includes instructions that are executed by the at least one processor 16, to provide the aforementioned functions of the remote desktop management system 11. A detailed description of the functions of the modules 200-240 is given in reference to FIG. 3.

FIG. 3 is a flowchart of one embodiment of a remote desktop management method using the computing device 10 of FIG. 1. Depending on the embodiment, additional steps may be added, others removed, and the ordering of the steps may be changed.

In step S301, the generation module 200 generates a webpage that lists all the remote devices 13. For example, the webpage includes a plurality of icons, each of which represents one of the remote devices 13.

When one of the remote devices 13 is selected by the control computer 12 from the webpage, in step S302, the generation module 200 determines a computer name and an IP address of the selected remote device 13, and receives display parameters of the selected remote device 13 from the control computer 12. Computer names and IP addresses of the remote device 13 may be pre-stored in the storage system 15. The generation module 200 may obtain the computer name and the IP address of the selected remote device 13 from the pre-stored computer names and IP addresses. The display parameters may include a resolution of a remote desktop of the selected remote device 13. For example, the resolution of the remote desktop of the selected remote device 13 is 512×384 pixels.

In step S303, the creation module 210 creates a component object model (COM) object that complies with a remote desktop protocol in the webpage. In one embodiment, the creation module 210 may output creation failure information on the webpage if the COM object fails to be created.

In step S304, the configuration module 220 configures the COM object according to the computer name, the IP address, and the display parameters of the selected remote device 13. As such, the COM object is bound to the selected remote device 13. For example, configuration parameters of the COM object include a computer name, an IP address, and display parameters. The configuration module 220 sets the computer name of the selected remote device 13 as the computer name of the COM object, sets the IP address of the selected remote device 13 as the IP address of the COM object, and sets the display parameters of the selected remote device 13 as the display parameters of the COM object.

In step S305, the determination module 230 determines an operating system used in the selected remote device 13. Operating system information of the selected remote device 13 may be recorded in a system configuration file of the selected remote device 13. The determination module 230 reads the system configuration file to obtain operating system information, and determines the operating system used in the selected remote device 13 according to the operating system information.

In step S306, the connection module 240 uses the COM object to establish a remote connection between the computing device 10 and the selected remote device 13 according to the operation system used in the selected remote device 13, and generates a remote desktop of the selected remote device 13 on the webpage. Therefore, users can access the webpage to manage the remote desktop of the selected remote device 13 via the control computer 12 without any remote desktop management application installed in the control computer 12. In one embodiment, the COM object invokes a connection function corresponding to the operating system to establish the remote connection to the selected remote device 13.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote desktop management method being executed by a processor of a computing device, the method comprising:
generating a webpage that lists a plurality of remote devices;
determining a computer name and an IP address of a remote device selected from the plurality of remote devices by a control computer, and receiving display parameters of the selected remote device from the control computer;
creating a component object model (COM) object that complies with a remote desktop protocol in the webpage;
configuring the COM object according to the computer name, the IP address, and the display parameters of the selected remote device;
determining an operating system used in the selected remote device; and
using the COM object to establish a remote connection between the computing device and the selected remote device according to the operation system used in the selected remote device, and generate a remote desktop of the selected remote device on the webpage.

2. The method of claim 1, further comprising:
outputting creation failure information on the webpage upon condition that the COM object fails to be created.

3. The method of claim 1, wherein the display parameters comprise a resolution of the remote desktop of the selected remote device.

4. The method of claim 1, wherein the control computer is connected to the control computer via a public or private network.

5. The method of claim 1, wherein the plurality of remote devices are physical machines or virtual machines.

6. A computing device, comprising:
a storage system;
at least one processor; and
a remote desktop management system comprising one or more programs that are stored in the storage system and executed by the at least one processor, the one or more programs comprising instructions to:
generate a webpage that lists a plurality of remote devices;
determine a computer name and an IP address of a remote device selected from the plurality of remote devices by a control computer, and receive display parameters of the selected remote device from the control computer;
create a component object model (COM) object that complies with a remote desktop protocol;
configure the COM object according to the computer name, the IP address, and the display parameters of the selected remote device;
determine an operating system used in the selected remote device; and
use the COM object to establish a remote connection between the computing device and the selected remote device according to the operation system used in the selected remote device and generate a remote desktop of the selected remote device on the webpage.

7. The computing device of claim 6, wherein the one or more programs further comprise instructions to:
output creation failure information on the webpage upon condition that the COM object fails to be created.

8. The computing device of claim 6, wherein the display parameters comprise a resolution of the remote desktop of the selected remote device.

9. The computing device of claim 6, wherein the control computer is connected to the control computer via a public or private network.

10. The computing device of claim 6, wherein the plurality of remote devices are physical machines or virtual machines.

11. A non-transitory computer-readable storage medium storing a set of instructions, the set of instructions capable of being executed by a processor of a computing device to implement a remote desktop management method, the method comprising:
generating a webpage that lists a plurality of remote devices;
determining a computer name and an IP address of a remote device selected from the plurality of remote devices by a control computer, and receiving display parameters of the selected remote device from the control computer;
creating a component object model (COM) object that complies with a remote desktop protocol in the webpage;
configuring the COM object according to the computer name, the IP address, and the display parameters of the selected remote device;
determining an operating system used in the selected remote device; and
using the COM object to establish a remote connection between the computing device and the selected remote device according to the operation system used in the selected remote device and generate a remote desktop of the selected remote device on the webpage.

12. The storage medium of claim 11, wherein the method further comprises:
outputting creation failure information on the webpage upon condition that the COM object fails to be created.

13. The storage medium of claim 11, wherein the display parameters comprise a resolution of the remote desktop of the selected remote device.

14. The storage medium of claim 11, wherein the control computer is connected to the control computer via a public or private network.

15. The storage medium of claim 11, wherein the plurality of remote devices are physical machines or virtual machines.
